(19) United States
(12) Patent Application Publication
(10) Pub. No.: US 2022/0351546 A1
(43) Pub. Date: Nov. 3, 2022

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Shunki Yamashita, Kanagawa (JP)

(21) Appl. No.: 17/730,003

(22) Filed: Apr. 26, 2022

(30) Foreign Application Priority Data
Apr. 28, 2021 (JP) 2021-076208

(51) Int. Cl. G06V 40/20; G06V 40/10; G06V 10/22

(52) U.S. Cl. CPC G06V 40/20; G06V 40/10; G06V 10/235; H04N 5/23296

(57) ABSTRACT

An information processing apparatus that performs a control for detecting a person from an image captured by an image capturing, detecting a first direction based on a gesture performed by the person, specifying, as an indicated region, a background information region including a background information in an image captured by the image capturing unit, in a case where the background information region and the first direction intersect; and adjusting an angle of view of the image capturing such that the person and the indicated region are included in the angle of view, wherein in a case where a plurality of background information regions in the image and the first direction intersect, the indicated region is specified corresponding to a background information region that fulfills a predetermined condition from among the plurality of background information regions.

### BACKGROUND

### Technical Field

The present disclosure relates to an information processing apparatus, an information processing method, and a storage medium.

### Description of the Related Art

In educational institutions, there is a need to use video images of lectures, which have been streamed in real-time or recorded, after the fact, and the like. In this type of lecture, the lecturer generally uses a screen, a blackboard, or the like to explain the contents of the lecture.

In order to automate the image capturing of these lectures, there is an image capturing method that uses human body (i.e. a person) tracking technology to capture images of the lecture by zooming in so that the lecturer's entire body, or their upper half, is included in the angle of view, and automatically moving the camera so that this is captured in the center of the angle of view. However, in image capturing using only human body tracking technology, there exists the problem that, although the lecturer is constantly displayed, the regions including lecture information that exist in the surroundings of the lecturer (referred to below as “lecture information regions”) are not sufficiently included in the display.

In Japanese Unexamined Patent Application Publication No. 2007-158680, while images are normally only captured of the lecturer using regular human body tracking technology, when the lecturer makes a specific gesture that indicates an arbitrary location, angle of view control that includes the indicated lecture information region is performed. An automatic image capturing system that also includes, not just the lecturer, but also indicated lecture information regions in the angle of view is thereby provided.

In Japanese Unexamined Patent Application Publication No. 2007-158680, processing is performed so that detection of the indicated region is performed based on the coordinates of the position that has been indicated by the lecturer's gesture.

However, in the technology that has been disclosed in the above-referenced Patent Publication, in the case in which a plurality of lecture information regions exists in the direction that has been indicated by the gesture, it is difficult to correctly determine the region that was actually indicated by the lecturer as the indicated region.

### SUMMARY

In view of the above issues, technology that that performs a control to include both the indicated region that has been indicated by a person's gesture and the person who performed the gesture in the angle of view in an image capturing apparatus would be preferable. One aspect of the present disclosure is an information processing apparatus comprising, at least one processor that executes the instructions and is configured to operate as: a person detection unit configured to detect a person from an image captured by an image capturing unit; a gesture detection unit configured to detect a first direction based on a gesture performed by the person; a specifying unit configured to specify, as an indicated region, a background information region including background information in an image captured by the image capturing unit, in a case where the background information region and the first direction intersect; and an angle of view adjustment unit configured to adjust an angle of view of the image capturing unit such that the person and the indicated region are included in the angle of view, wherein in a case where a plurality of background information regions in the image and the first direction intersect, the specifying unit specifies, as the indicated region, a background information region that fulfills a predetermined condition from among the plurality of background information regions.

Further features of the present disclosure will become apparent from the following description of Embodiments with reference to the attached drawings.

### BRIEF DESCRIPTION OF THE DRAWINGS

FIG. 1 is a block diagram showing a functional configuration of an image capturing system including an angle of view adjustment apparatus according to the First Embodiment.

FIG. 2 is a diagram explaining human body region detection according the First Embodiment.

FIG. 3 is a diagram showing an example of joint estimation results according to the First Embodiment.

FIG. 4 is a diagram explaining gesture detection according to the First Embodiment.

FIG. 5 is a diagram explaining acquisition of direction information that has been indicated by a gesture according to the First Embodiment.

FIG. 6 is a diagram explaining background information region detection processing and background information region storage processing according to the First Embodiment.

FIG. 7 is a diagram explaining candidate acquisition processing according to the First Embodiment.

FIG. 8 is a diagram explaining indicated region specification processing according to the First Embodiment.

FIG. 9 is a diagram explaining indicated region specification processing according to the First Embodiment.

FIG. 10 is a diagram explaining angle of view calculation processing according to the First Embodiment.

FIG. 11 is a diagram explaining angle of view calculation processing according to the First Embodiment.

FIG. 12 is a diagram showing an example of a hardware configuration of an angle of view adjustment apparatus according to the First Embodiment.

FIG. 13 is a flowchart showing an example of processing in an image capturing system according to the First Embodiment.

FIG. 14 is a flow chart showing an example of processing in an image capturing system according to the First Embodiment.

FIG. 15 is a flow chart showing an example of indicated region specification processing according to the First Embodiment.

FIG. 16 is a block diagram showing a functional configuration of an image capturing system including an angle of view adjustment apparatus according to the Second Embodiment.

FIG. 17 is a diagram explaining indicated region specification processing according to the Second Embodiment.

FIG. 18 is a diagram explaining indicated region specification processing according to the Second Embodiment.

FIG. 19 is a flowchart showing an example of processing in an image capturing system according to the Second Embodiment.

FIG. 20 is a flowchart showing an example of processing in an image capturing system according to the Second Embodiment.

FIG. 21 is a flowchart showing an example of indicated region specification processing according to the Second Embodiment.

FIG. 22 is a block diagram showing a functional configuration of an image capturing system including an angle of view adjustment apparatus according to the Third Embodiment.

FIG. 23 is a diagram explaining indicated region specification processing according to the Third Embodiment.

FIG. 24 is a flowchart showing an example of processing in an image capturing system according to the Third Embodiment.

FIG. 25 is a flowchart showing an example of processing in an image capturing system according to the Third Embodiment.

FIG. 26 is a flowchart showing an example of indicated region specification processing according to the Third Embodiment.

### DESCRIPTION OF THE EMBODIMENTS

Hereinafter, with reference to the accompanying drawings, the present disclosure will be described using Embodiments. In each diagram, the same reference signs are applied to the same members or elements, and duplicate descriptions will be omitted or simplified.

### First Embodiment

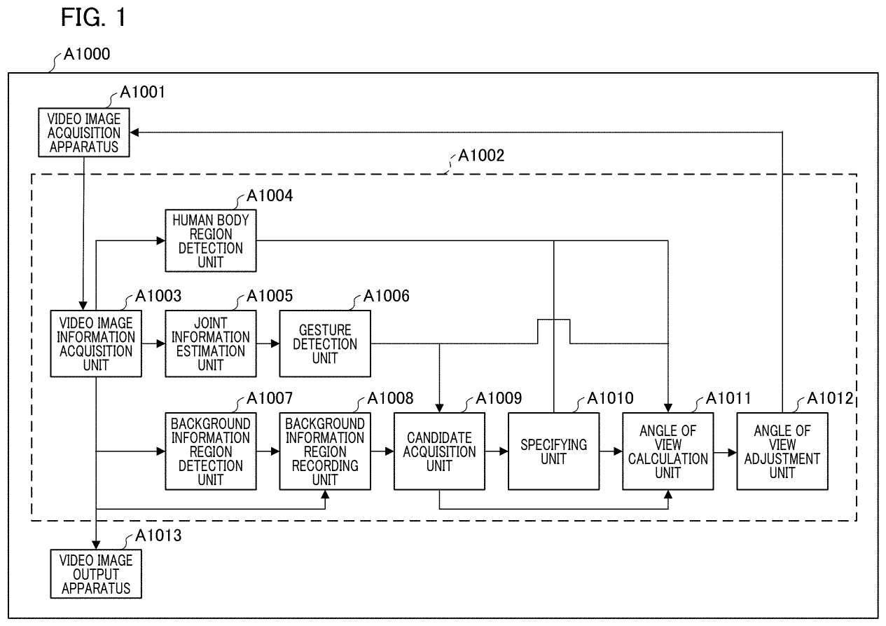

An example of a configuration of an angle of view adjustment apparatus according to the First Embodiment of the present disclosure will be explained with reference to FIG. 1. FIG. 1 is a block diagram showing a functional configuration of an image capturing system (automatic image capturing system) including an angle of view adjustment apparatus according to the First Embodiment.

An image capturing system A1000 (automatic image capturing system) detects a human body (i.e. a person) from a video image that has been captured by a video image acquisition apparatus A1001, zooms in so that the entirety or the upper half of that human body (the person) is included in the angle of view, and manipulates the angle of view so that this is centered in the angle of view via an angle of view adjustment apparatus A1002. Then, the video image that has been obtained is output to a video image output apparatus A1013. Furthermore, in the exemplary case in which, during the human body (the person) tracking, the human body (the person) performs a gesture that indicates a background such as writing on a board, angle of view manipulation will be performed so that both the region including the human body (the human body region, the person region) and the region that has been indicated by the human body (indicated region) are included in the angle of view. Then, the video image that has been obtained will be output to the video image output apparatus A1013. The image capturing system A1000 has a video image acquisition apparatus A1001, an angle of view adjustment apparatus A1002, and a video image output apparatus A1013. The angle of view adjustment apparatus A1002 and the video image output apparatus A1013 can be connected via a video interface. In the following embodiments, the human body may also be referred to as the person.

The video image acquisition apparatus A1001 is an apparatus configured to generate captured video images by capturing images of an image capturing target, and is configured by a camera or the like. That is, the video image acquisition apparatus A1001 can be provided with an image capturing optical system and an image capturing element. The video image acquisition apparatus A1001 outputs the video image information (image data) that has been captured as well as the pan, tilt, and zoom values during the video image acquisition to the angle of view adjustment apparatus A1002.

Upon acquiring the video image information from the video image acquisition apparatus A1001, the angle of view adjustment apparatus A1002 performs detection of the human body region, estimation of the joint information for the human body, and detection of the background information region from the video image information. The indicating gesture is detected from the estimated joint information, and specification of the indicated region is performed. In this context, the indicating gesture is a gesture that is performed by the human body that is included in the video image information and that indicates an arbitrary direction. In the case in which the indicated region is specified, the angle of view adjustment apparatus A1002 performs angle of view adjustment so that both regions of the indicated region and the human body region are included in the angle of view. The video image for which the angle of view has been adjusted is output to the video image output apparatus A1013. The angle of view adjustment apparatus A1002 has a video image information acquisition unit A1003, a human body region detection unit A1004, a joint information estimation unit A1005, and a gesture detection unit A1006. Furthermore, the angle of view adjustment apparatus A1002 also has a background information region detection unit A1007, a background information region recording unit A1008, a candidate acquisition unit A1009, a specifying unit A1010, an angle of view calculation unit A1011, and an angle of view adjustment unit A1012.

The video image information acquisition unit (image acquisition unit) A1003 acquires the video image information that has been captured by the video image acquisition apparatus A1001, and outputs the acquired video image information to the human body region detection unit A1004, the joint information estimation unit A105, the background information region detection unit A1007, and the video image output apparatus A1013. In addition, the pan, tilt, and zoom values during the video image acquisition that have been output from the video image acquisition apparatus A1001 are output to the background information region recording unit A1008.

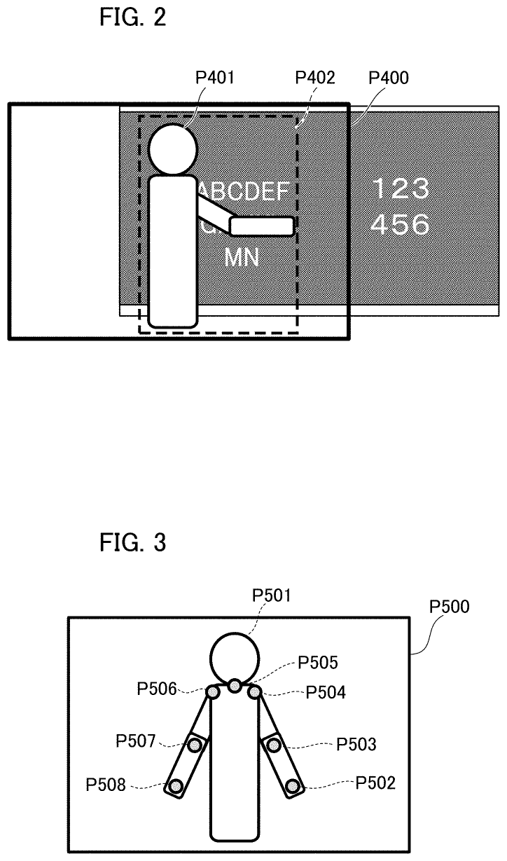

The human body region detection unit A1004 will be explained using FIG. 2. FIG. 2 is a diagram explaining human body region detection according the First Embodiment. The human body region detection unit A1004 performs region detection processing for the human body region, which is a region in the video image including a human body P401, from the video image information P400 that has been input from the video image information acquisition unit A1003. The detection processing for the human body region may use any method as long as it is capable of detecting a human body region such as a template matching method, a meaningful region separation method, or the like. The human body region detection unit A1004 outputs the detected human body region information P402 to the specifying unit A1010, and the angle of view calculation unit A1011.

The joint information estimation unit A1005 estimates the joint information for the human body in the video image based on the video image information that has been input from the video image information acquisition unit A1003. In recent years, a large number of joint estimation technologies using Deep Learning have appeared, and it has become possible to estimate the joints of a human body with a high degree of precision. Among these, there are also technologies that have been provided on OSS (Open-Source Software) such as OpenPose and DeepPose which perform joint estimation. Although the present disclosure does not stipulate a particular joint estimation technology, it will be assumed that, for example, one from among the joint estimation technologies that use Deep Learning such as those that are described above is used. The joint information estimation unit A1005 estimates the joint information by using joint estimation technology on the human body in the video image. The estimated joint information is output to the gesture detection unit A1006.

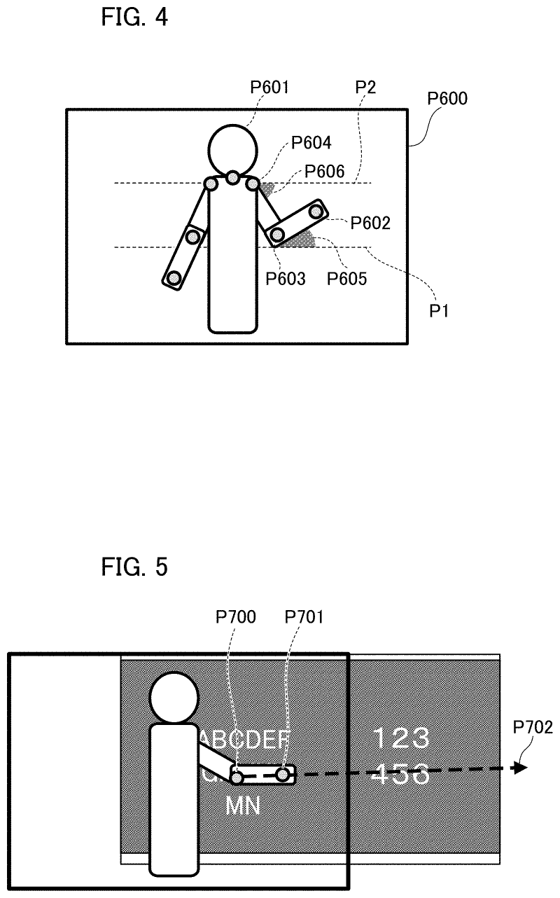

The gesture detection unit A1006 performs detection of the indicating gesture based on the joint information that has been input from the joint information estimation unit A1005. This aspect will be explained using FIGS. 3, 4, and 5. FIG. 3 is a diagram showing an example of joint estimation results according to the First Embodiment. This diagram shows, from among the joint estimation results for the human body that were acquired from the joint information estimation unit A1005, the joint information that is used to detect the gesture. P500 shows the video image information, and P501 shows the human body. P502, P503, P504, P505, P506, P507, and P508 each show the left wrist, the left elbow, the left shoulder, the neck, the right shoulder, the right elbow, and the right wrist. FIG. 4 is a diagram explaining gesture detection according to the First Embodiment. In this context, the conditions for the case in which a gesture made by the left arm of the human body is detected is explained as an example. P600 shows the video image information, and P601 shows the human body. If the angle formed on the reference surface P1 by the left wrist P602 and the left elbow P603 is made P605, and the angle formed on the reference surface P2 by the left elbow P603 and the left shoulder P604 is made P606, then the indicating gesture can be detected when P605 and P606 are equal to or greater than 0° and less than 90°.

FIG. 5 is a diagram explaining acquisition of direction information indicated by a gesture according to the First Embodiment. When the gesture is detected, for example, as is shown in FIG. 5, the dotted line P702 that passes through the left wrist P701 with the left elbow P700 as the starting point is calculated and acquired as the indicated direction information (first direction information), and this is output to the candidate acquisition unit A1009. The indicated direction information includes information relating to the direction that has been indicated by a gesture indicating an arbitrary direction performed by a human body. This is one example, and therefore, any method may be used and long as it is capable of detecting an indicating gesture by using joint information and calculating the indicated direction information. In addition, in the case in which it is possible to detect the indicated direction of the gesture made by the human body without using the joint information, it is not always necessary to use the joint information. Note that in this context, in the case in which a gesture is not detected, gesture not detected information will be output to the angle of view calculation unit A1011.

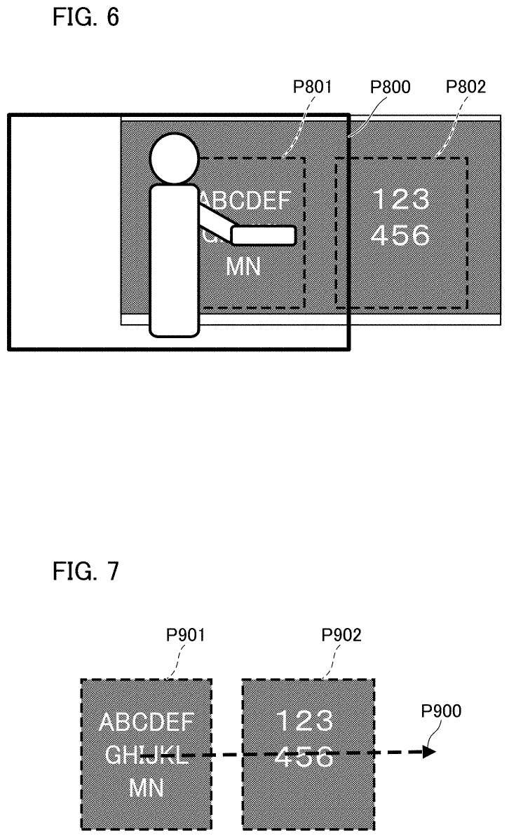

The background information region detection unit A1007 will be explained using FIG. 6. FIG. 6 is a diagram explaining background information region detection processing and background information region storage processing according to the First Embodiment. The background information region detection unit A1007 detects a background information region P801 based on the video image information P800 that has been input from the video image information acquisition unit A1003. The background information includes character strings or figures drawn on a board by a speaker such as a lecturer or the like, or slides that are being used for the lecture, explanation, or presentation being made by a person (a human body) included in the video image information, and the like. That is, the background information can also be said to be lecture information, explanatory information, or written information that includes information related to character strings or figures that the human body is using for a lecture, explanation, or presentation. The background information region is a region that includes this background information, and is a region in which character strings or figures written on a board are gathered according to distance, or a region that includes slides or the like that are being used in a lecture or the like. For example, region segmentation processing is used for the background information region detection. Various methods for region segmentation processing are known, such as, for example, region split and Super-parsing, fully CNN (Convolution Neural Network) by Deep Learning, or the like. However, any method may be used. The background information region P801 that has been detected is output to the background information region recording unit A1008.

The background information region recording unit A1008 will also be explained using FIG. 6. The background information region recording unit A1008 adds the pan, tilt, and zoom values during image capturing that have been input from the video image information acquisition unit A1003 to the background information region P801 that has been input from the background information region detection unit A1007, and records this. By recording this together with the pan, tilt, and zoom values even in the case in which the background information region exceeds the image capturing angle of view as in P802, this cannot be treated the same way as the background information region in the screen. The background information region groups that have been recorded are output to the candidate acquisition unit A1009.

The candidate acquisition unit A1009 will be explained using FIG. 7. FIG. 7 is a diagram explaining candidate acquisition processing according to the First Embodiment. The candidate acquisition unit A1009 calculates and acquires (or selects) candidates for the indicated region (candidate regions) from the indicated direction information P900 that has been input from the gesture detection unit A1006, and the background information region groups that have been input from the background information region recording unit A1008 (regions P901 and P902). In the calculation of the candidates for the indicated region, when the indicated direction information is made a vector, and each background information region from the background information region groups is made a quadrilateral, the background information regions in which the vectors and the quadrilaterals intersect become the candidates for the indicated region. In the circumstances shown in FIG. 7, both regions P901 and P902 intersect with the indicated vector (indicated direction information P900), and therefore, region P901 and region P902 become candidates for the indicated region. The information for the candidate regions that have been acquired by calculation are output to the specifying unit A1010. In the case in which no background information regions that intersect with the indicated direction vector exist, a candidate not acquired notification is output to the angle of view calculation unit A1011.

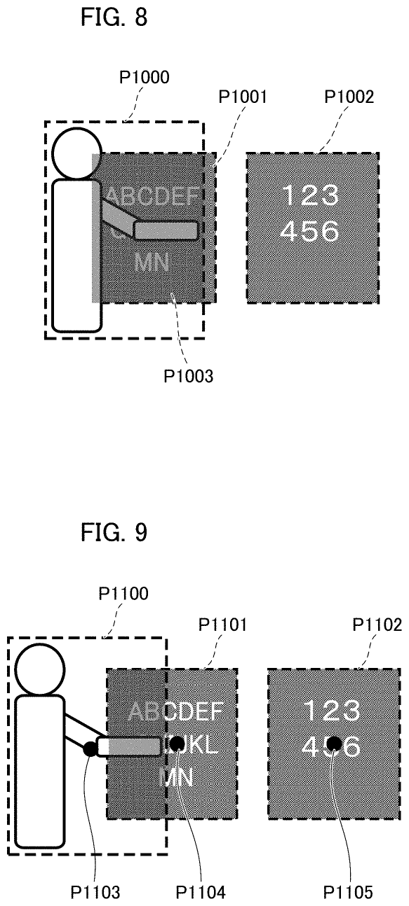

The specifying unit A1010 will be explained using FIGS. 8 and 9. FIGS. 8 and 9 are diagrams explaining indicated region specification processing according to the First Embodiment. As is shown in FIG. 8, the specifying unit A1010 specifies one indicated region from the human body region information P1000 that has been input from the human body region detection unit A1004 and the candidate region information that has been input from the candidate acquisition unit A1009 (regions P1001 and P1002). If there is only one candidate region, the specifying unit A1010 directly makes that region the indicated region. If multiple candidate regions exist, the degree of overlap for the overlapping region P1003 in which the human body region and each of the candidate regions overlap is calculated, and the indicated region is specified based on the degree of overlap. For example, the degree of overlap for the human body region P1000 and the region P10001 can be calculated as [the area of the overlapping region P1003]÷[the area of P1001]. In the case in which the degree of overlap exceeds a threshold of, for example, 0.7, the region P1001 will be excluded from the candidates. The degree of overlap is calculated in the same manner for the region P1002. In the case in which the region P1002 is the only candidate for which the degree of overlap is at or below the threshold, P1002 is specified as the indicated region, and this is output to the angle of view calculation unit A1011. In the case in which the degree of overlap for the region P1002 also exceeds the threshold, and there is no candidate with a degree of overlap that is at or below the threshold, an indicated region not specified notification is output to the angle of view calculation unit A1011. However, as is shown in FIG. 9, in the case in which the degree of overlap for the human body region P1100 and the regions P1101/P1102 are both at or below the threshold, the distance between the center P1103 of the human body region and the centers P1104 and P1105 of each candidate regions are calculated. Then, the region P1101, which is the candidate for which this distance is smaller, or, preferably, which is the candidate for which this distance is the smallest, is specified as the indicated region. In this case as well, the indicated region is output to the angle of view calculation unit A1011 in the same manner.

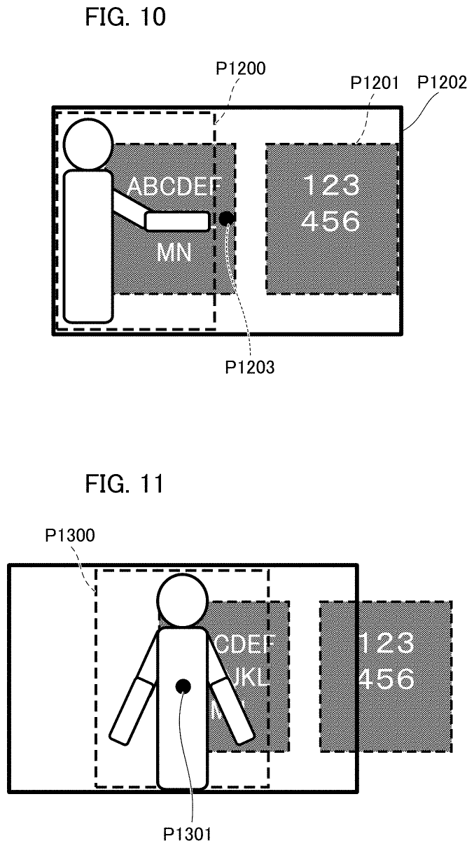

The angle of view calculation unit A1011 will be explained using FIG. 10. FIGS. 10 and 11 are diagrams explaining angle of view calculation processing according to the First Embodiment. The angle of view calculation unit A1011 calculates the pan, tilt, and zoom values based on the human body region P1200 that has been input from the human body region detection unit A1004, and the indicated region P1201 that has been input from the specifying unit A1010. Specifically, the angle of view calculation unit A1011 calculates the pan, tilt, and zoom values in order to capture images of the circumscription rectangle P1202 for both of the regions of the human body region P1200 and the indicated region P1201 using the video image acquisition apparatus A1001. The calculation for the pan and tilt values is calculated so that the center of the angle of view is at the center P1203 of P1202. In addition, the zoom value is also calculated so that P1202 is included in the angle of view.

However, in the case in which a gesture not detected notification, a candidate not detected notification, or an indicated region not specified notification is input, the angle of view calculation unit A1011 calculates the pan, tilt, and zoom values so that the human body region P1300 is included in the angle of view. Specifically, the angle of view calculation unit A1011 calculates the pan and tilt so that the human body region P1300 is included in the angle of view, and the center P1301 of the human body region is captured in the center of the angle of view, and calculates the zoom value so that the human body region P1300 is included in the angle of view, as is shown in FIG. 11.

The calculated pan, tilt, and zoom values are output to the angle of view adjustment unit A1012.

The angle of view adjustment unit A1012 manipulates the pan, tilt, and zoom of video image acquisition apparatus A1001 based on the pan, tilt, and zoom values that have been input from the angle of view calculation unit A1011.

Note that angle of view adjustment may be performed in such a way that in the case in which the distance between the center of the human body region and the center of the indicated region is at or above a specified threshold, both the human body region and the indicated region are made to be included in the angle of view and at least one of the human body region or the indicated region may be extracted. For example, specifically, the angle of view calculation unit A1011 calculates the pan, tilt, and zoom values so that the display region for displaying the human body region and the indicated region are included in the angle of view. And, by synthesizing the indicated region, which has been selected and extracted in the display region, an image is generated that includes both the human body region and the indicated region. By carrying out this kind of processing, the background information becomes easily visible on the display screen even in cases in which the human body region and the indicated region are separated.

The video image output apparatus A1013 is an apparatus configured to make it possible for the user to view or save the video image information that has been input from the video image information acquisition unit A1003, and has a display unit such as a monitor, a display, or the like.

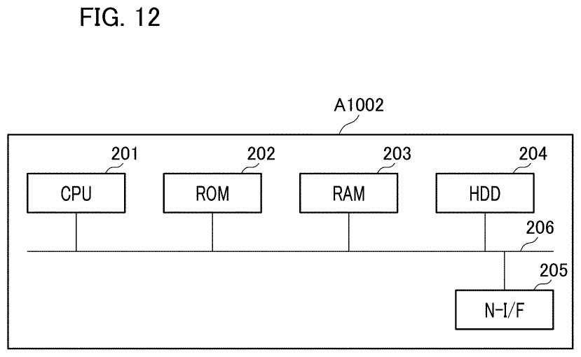

FIG. 12 is a diagram showing an example of a hardware configuration of an angle of view adjustment apparatus A1002 according to the First Embodiment. The angle of view adjustment apparatus A1002 includes a CPU 201, a ROM 202, a RAM 203, an HDD 204, and network interface (N-I/F) 205, which are connected to each other via a system bus 206. The network interface 205 can be connected to, for example, a network such as LAN (Local Area Network) or the like.

The CPU 201 is a control apparatus such as a CPU (Central Processing Unit) or the like that integrally controls the angle of view adjustment apparatus A1002. The ROM 202 is a storage device that stores each type of program for the CPU 201 to control the angle of view adjustment apparatus A1002. The angle of view adjustment apparatus A1002 may also have a secondary storage device instead of the ROM 202. The RAM 203 expands the program that has been read out by the CPU 201 from the ROM 202, and is a memory configured to function as the work area and the like of the CPU 201. In addition, the RAM 203 serving as a temporary storage memory can also function as a storage region for temporarily storing the data that will become the targets of each type of processing.

The HDD 204 is a storage device that stores each type of data such as the video image information and the like that is input from the video image acquisition apparatus A1001. Video image information is the image data that is the target of the human body detection performed by the angle of view adjustment apparatus A1002 in the Present Embodiment. In the case in which the video image information is stored on a different storage device (for example, the ROM 202, an external storage device, or the like), the angle of view adjustment apparatus A1002 does not necessarily need to have an HDD 204.

The network interface 205 is a circuit that is used in communications with external devices and the like via a network (for example, a LAN). The CPU 201 acquires video image information from the video image acquisition unit A1001, via the network, and is able to output video image information for which the angle of view has been adjusted to the video image output apparatus A1013. In addition, the CPU 201 is able to control the pan, tilt, and zoom of the video image acquisition apparatus A1001 via the network.

Note that the angle of view adjustment apparatus A1002 may also be provided with input units such as a keyboard, a mouse, a touch panel, and the like, and display units such as a display or the like.

The CPU 201 implements the functions of the angle of view adjustment apparatus A1002 to be described below by executing processing based on a program (set of executable instructions) that has been stored on the ROM 202, the HDD 204, or the like. In addition, the CPU 201 also implements the processing of the flow charts to be described below by executing processing based on the program that has been stored on the ROM 202, the HDD 204, or the like.

As was described above, the hardware configuration of the angle of view adjustment apparatus A1002 has the same hardware configuration elements as the hardware configuration elements that are built into a PC (personal computer) or the like. Therefore, the angle of view adjustment apparatus A1002 of the Present Embodiment can also be configured by an information processing apparatus such as a PC, tablet device, server apparatus, or the like. In addition, each type of function and the like that the angle of view adjustment apparatus A1002 of the Present Embodiment has can be implemented as an application that operates on an information processing apparatus such as a PC or the like.

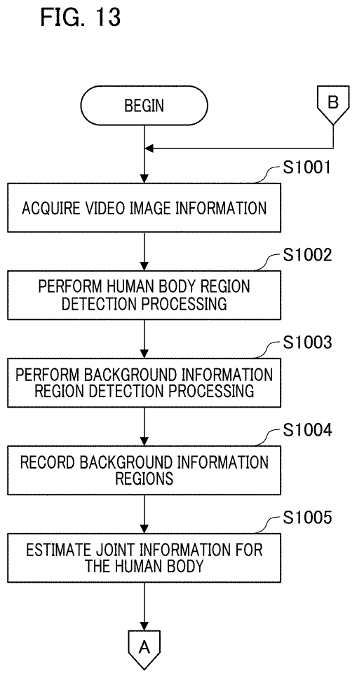

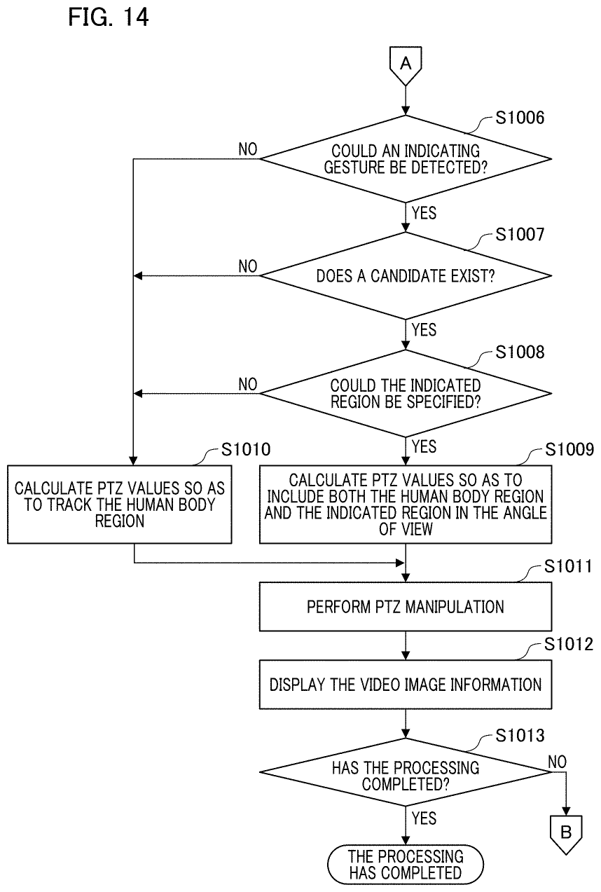

Next, an exemplary order in which the processing of the image capturing system is carried out will be explained while referencing the flow charts in FIGS. 13 and 14. FIGS. 13 and 14 are flowcharts showing examples of processing in an image capturing system according to the First Embodiment. Each of the operations (steps) shown in these flow charts can be executed by the CPU 201 controlling each unit.

Automatic image capturing begins when the image capturing system A100 is turned on by a user operation, and first, in S1001, the video image information acquisition unit A1003 acquires video image information from the video image acquisition apparatus A1001. The video image information is output to the human body region detection unit A1004, the joint information estimation unit A1005, the background information region detection unit A1007, and the video image output apparatus A1013. In addition, the pan, tilt, and zoom values that have been acquired from the video image acquisition apparatus A1001 are output to the background information region recording unit A1008. Then, the processing proceeds to S1002.

In S1002, the human body region detection unit A1004 performs human body detection processing based on the video image information that has been acquired from the video image information acquisition unit A1003, and outputs the detection results to the specifying unit A1010, and the angle of view calculation unit A1011. Then, the processing proceeds to S1003.

In S1003, the background information region detection unit A1007 performs background information region detection processing by using the video image information that has been acquired from the video image information acquisition unit A1003, and outputs the detection results to the background information region recording unit A1008. Then, the processing proceeds to S1004.

In S1004, the background information region recording unit A1008 records background information regions based on the background information region detection results that have been input from the background information region detection unit A1007, and the pan, tilt, and zoom values during image capturing that have been input from the video image information acquisition unit A1003. Then the processing proceeds to S1005.

In S1005, the joint information estimation unit A1005 estimates the joint information for the human body in the video image, and outputs the estimated joint information to the gesture detection unit A1006. Then, the processing proceeds to S1006.

In S1006, the gesture detection unit A1006 detects the indicating gesture from the joint information. In the case in which a gesture can be detected (S1006 Yes), the direction information that was indicated by the gesture is calculated, the direction information is output to the candidate acquisition unit A1009, and the processing proceeds to S1007. In the case in which a gesture cannot be detected (S1006 No), a gesture not detected notification is output to the angle of view calculation unit A1011, and the processing proceeds to S1010.

In S1007, the candidate acquisition unit A1009 calculates candidate regions based on the background information region information groups that have been input from the background information region recording unit A1008 and the indicated direction information that has been input from the gesture detection unit A1006. In the case in which a candidate region exists (S1007 Yes), the candidate region information is output to the specifying unit A1010, and the processing proceeds to S1008. In the case in which candidate regions do not exist (S1007 No), a candidate not detected notification is output to the angle of view calculation unit A1011, and the processing proceeds to S1010.

In S1008, the specifying unit A1010 specifies the indicated region based on the human body region information that has been input from the human body region detection unit A1004 and the indicated region candidate information that has been input from the candidate acquisition unit A1009. In the case in which an indicated region can be specified (S1008 Yes), the specified indicated region is output to the angle of view calculation unit A1011, and the processing proceeds to S1009. In the case in which a indicated region cannot be specified (S1008 No), an indicated region not specified notification is output to the angle of view calculation unit A1011, and the processing proceeds to S1010.

In S1009, the angle of view calculation unit A1011 calculates pan, tilt, and zoom values based on the human body region information that has been input from the human body region detection unit A1004 and the indicated region that has been input from the specifying unit A1010 such that the human body region and the indicated region are both included in the angle of view. The angle of view calculation unit A1011 outputs the calculated pan, tilt, and zoom values to the angle of view adjustment unit A1012, and the processing proceeds to S1010.

In S1010, the angle of view calculation unit A1011 acquires a gesture not detected notification from the gesture detection unit A1006, a candidate not detected notification from the candidate acquisition unit A1009, or an indicated region not specified notification from the specifying unit A1010. Thus, the angle of view calculation unit A1011 calculates the pan, tilt, and zoom values such that the human body region is captured in the center of the angle of view. The calculated pan, tilt, and zoom values are output to the angle of view adjustment unit A1012, and the processing proceeds to S1011.

In S1011, the angle of view adjustment unit A1012 manipulates the video image acquisition apparatus A1101 based on the pan, tilt, and zoom values that have been input from the angle of view calculation unit A1011. Then, the processing proceeds to S1012.

In S1012, the video image output apparatus A1013 displays the video image information that has been input from the video image information acquisition unit A1003. Then, the processing proceeds to S1013.

In S1013, whether or not the On/Off switch of the automatic image capturing system, which is not shown, has been operated by a user operation, and an operation has been performed to stop the automatic image capturing processing are determined. In the case that this is false (S1013 No), the processing proceeds to S1001, and in the case in which it is true (S1013 Yes), the automatic image capturing processing is completed.

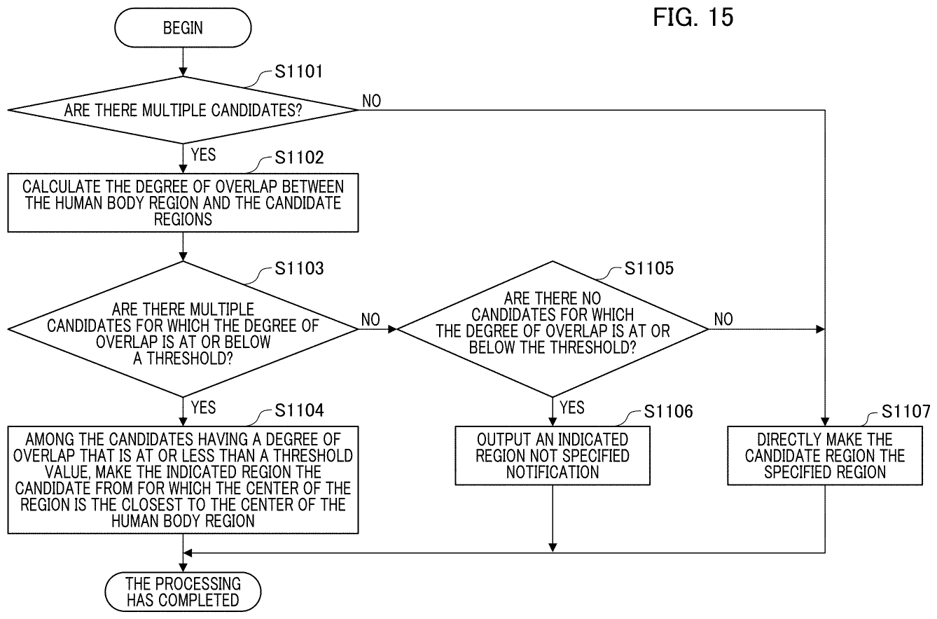

In addition, a more detailed explanation of the order of the indicated region specification processing that is performed in S1008 will be given with reference to the flowchart in FIG. 15. FIG. 15 is a flow chart showing an example of indicated region specification processing according to the First Embodiment. Each of the operations (steps) that are shown in this flowchart can be executed by the CPU 201 controlling each unit.

First, in S1101, the specifying unit A1010 determines whether or not multiple candidate regions exist based on the candidate region information that has been input from the candidate acquisition unit A1009. In the case in which multiple candidate regions exist (S1101 Yes), the processing proceeds to S1102. In the case in which there is one candidate region (S1101 No), the processing proceeds to S1107.

In S1102, the specifying unit A1010 calculates the degree of overlap (i.e. an overlap amount) for each candidate region and the human body region based on the human body region that has been input from the human body region detection unit A1004 and the candidate region information that has been input from the candidate acquisition unit A1009. Then, the processing proceeds to S1103.

In S1103, the specifying unit A1010 determines if multiple candidates exist for which the degree of overlap (i.e. the overlap amount) that was calculated in S1102 is at or below the threshold. In the case in which multiple candidates for which the degree of overlap is at or below the threshold exist (S1103 Yes), the processing proceeds to S1104. In the case in which multiple candidates for which the degree of overlap is at or below the threshold do not exist (S1103 No), the processing proceeds to S1105.

In S1104, the specifying unit A1010 specifies the indicated region as the region from among the candidate regions for which the center is the closest to the center of the human body region. Then, the indicated region specification processing S1008 is completed.

In S1105, the specifying unit A1010 determines whether one candidate for which the degree of overlap is at or below the threshold exists or does not exist. In the case in which a candidate for which the degree of overlap is at or below the threshold does not exist (S1105 Yes), the processing proceeds to S1106. In the case in which one candidate exists for which the degree of overlap is at or below the threshold (S1105 No), the processing proceeds to S1107.

In S1106, the specifying unit A1010 outputs an indicated region not specified notification to the angle of view calculation unit A1011. Then the indicated region specification processing S1008 is completed.

In S1107, the specifying unit A1010 directly specifies the one candidate region as the indicated region, and outputs this to the angle of view calculation unit A1011. Then the indicated region specification processing S1008 is completed.

By performing angle of view manipulation that includes not only a human body, but also an indicated region in the case in which an indicating gesture has been performed by the human body shown in the video image, the above automatic image capturing system is able to perform image capturing in which the viewers can more easily understand the circumstances. Furthermore, even if a plurality of background information regions exists in the indicated position and direction, it is possible to perform image capturing that includes the background information region that has a high possibility of being indicated the angle of view.

### Second Embodiment

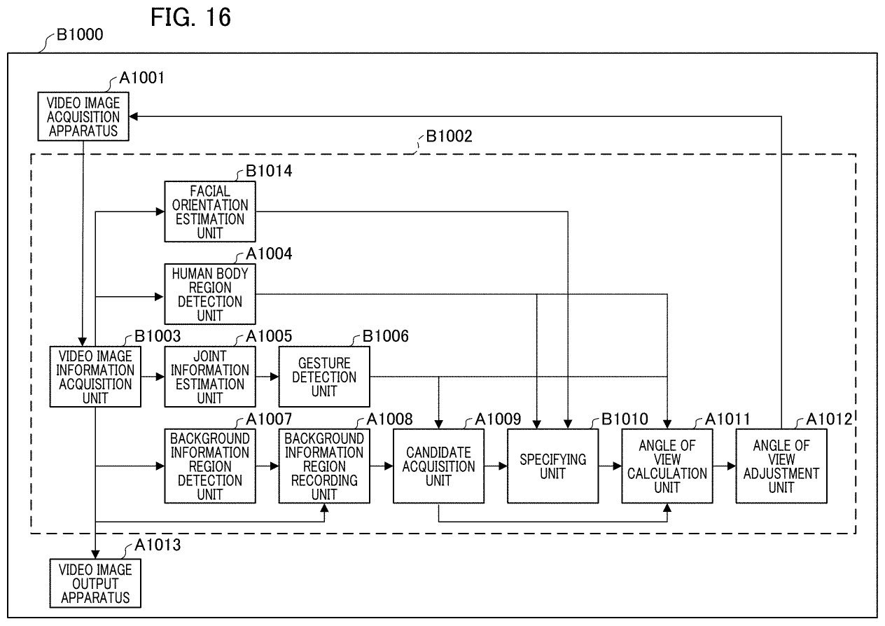

An example of the configuration of an angle of view adjustment apparatus according to the Second Embodiment of the present disclosure will be explained with reference to FIG. 16. FIG. 16 is a block diagram showing a functional configuration of an image capturing system including an angle of view adjustment apparatus according to the Second Embodiment.

The image capturing system B1000 detects a human body from the video image that has been captured by the video image acquisition apparatus A1001, and zooms in so that the entirety or the upper half of the human body is included in the angle of view, and performs angle of view manipulation so that the human body is captured in the center of the angle of view via an angle of view adjustment apparatus B1002. Then, the video image that has been obtained is output to the video image output apparatus A1013. Furthermore, during the human body tracking, in the case in which this human body performs an indicating gesture, a video image that has been obtained by performing angle of view manipulation such that both of the human body region and the indicated region are included in the angle of view is output to the video image output apparatus A1013. The image capturing system B1000 has a video image acquisition apparatus A1001, an angle of view adjustment apparatus B1002, and a video image output apparatus A1013. The angle of view adjustment apparatus B1002 and the video image output apparatus A1013 can be connected via a video interface.

When the video image is input from the video image acquisition apparatus A1001, the angle of view adjustment apparatus B1002 estimates the orientation of the face, detects the human body region, estimates the joint information of this human body, and detects background information regions. An indicating gesture is detected from the estimated joint information, and an indicated region is specified. In the case in which an indicated region is specified, the angle of view adjustment apparatus B1002 performs angle of view adjustment such that both regions of the indicated region and the human body region are included in the angle of view. The video image for which the angle of view has been adjusted is output to the video image output apparatus A1013. The angle of view adjustment apparatus B1002 has a video image information acquisition unit B1003, a facial orientation estimation unit B1014, a human body region detection unit A1004, a joint information estimation unit A1005, and a gesture detection unit B1006. Furthermore, the angle of view adjustment apparatus B1002 also has a background information region detection unit A1007, a background information region recording unit A1008, a candidate acquisition unit A1009, a specifying unit B1010, an angle of view calculation unit A1011, and an angle of view adjustment unit A1012.

The video image information acquisition unit B1003 acquires the video image information that has been captured by the video image acquisition apparatus A1001. Then, the acquired video image information is output to the facial orientation estimation unit B1014, the human body region detection unit A1004, the joint information estimation unit A1005, the background information region detection unit A1007, and the video image output apparatus A1013. In addition, the pan, tilt, and zoom values during video image acquisition that have been input from the video image acquisition apparatus A1001 are output to the background information region recording unit A1008.

The facial orientation estimation unit B1014 estimates the facial orientation of the human body in the video image based on the video image information that has been input from the video image information acquisition unit B1003. In recent years, a large number of facial orientation estimation technologies using Deep Learning have been published, and it has become possible to estimate facial orientation with a high degree of precision. Among these, there are also technologies that are provided on OSS (Open-Source Software) such as OpenFace, and it has become easy to perform facial orientation estimation. Although the present case does not stipulate a particular facial orientation estimation technology, it will be assumed that, for example, one from among these facial orientation estimation technologies using Deep Learning is used. The facial orientation information is acquired by estimation on a plane in the screen by using facial orientation estimation technology on the human body in the video image. The facial orientation information includes information related to the orientation direction of the face of a human body. The acquired facial orientation information is output to the gesture detection unit B1006.

The gesture detection unit B1006 detects an indicating gesture from the joint information that has been input from the joint information estimation unit A1005. The indicating gesture detection processing is the same as that of the gesture detection unit A1006 according to the First Embodiment, and therefore a detailed description thereof will be omitted. When a gesture is detected, the gesture detection unit B1006 calculates the indicated direction information in the same manner as the gesture detection unit A1006 and outputs this to the candidate acquisition unit A1009, and the specifying unit B1010. In addition, in the case in which no gesture is detected, gesture not detected information is output to the angle of view calculation unit A1011.

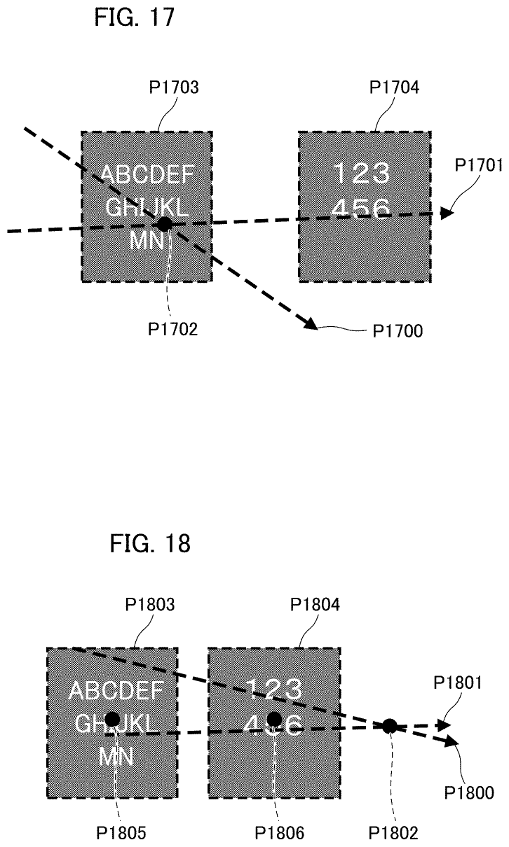

The specifying unit B1010 will be explained by using FIGS. 17 and 18. FIGS. 17 and 18 are diagrams explaining the indicated region specification processing according to the Second Embodiment. The specifying unit B1010 specifies one indicated region based on the facial orientation information, the human body region information, the indicated direction information, and the indicated region candidates. If there is only one candidate region, that region is directly made the indicated region. If multiple candidate regions exist, the facial orientation information P1700 and the indicated direction information P1701 are used to calculated the point of intersection P1702 thereof, as is shown in FIG. 17. In the case in which a region that includes the point of intersection P1702 exists among the candidate regions, the specifying unit B1010 specifies this candidate region as the indicated region, and outputs the indicated region that has been specified to the angle of view calculation unit A1011. In the circumstances that are shown in FIG. 17, from among the regions P1703 and P1704, which are the candidate regions, the region P1703 includes the point of intersection P1702, and therefore, the specifying unit B1010 specifies the region P1703 as the indicated region, and outputs this to the angle of view calculation unit A1011.

As is shown in FIG. 18, there are cases in which the point of intersection P1802 of the facial orientation information P1800 and the indicated direction information P1801 is not included in either the region P1803 or the region P1804, which are the candidate regions. In such a case, the specifying unit B1010 calculates the distance between the centers P1805 and P1806 of each of the candidate regions and the point of intersection P1802. Then, the candidate region that includes the center with the smaller distance thereto, preferably, the candidate region that includes the center with the smallest distance thereto, is specified as the indicated region, and is output to the angle of view calculation unit A1011. In the circumstances shown in FIG. 18, the distance between the center of the region P1804, which is a candidate region, and the point of intersection P1802 is the smallest, and therefore, P1804 is specified as the indicated region, and this is output to the angle of view calculation unit A1011. In the case in which the point of intersection between the facial orientation information and the indicated direction information cannot be calculated, the distance between the center of the human body region and the centers of each of the candidate regions is calculated, and the candidate region with the smallest distance therebetween is specified as the indicated region, and this is output to the angle of view calculation unit A1011. The blocks other than these are the same as those in the First Embodiment, and descriptions thereof will therefore be omitted.

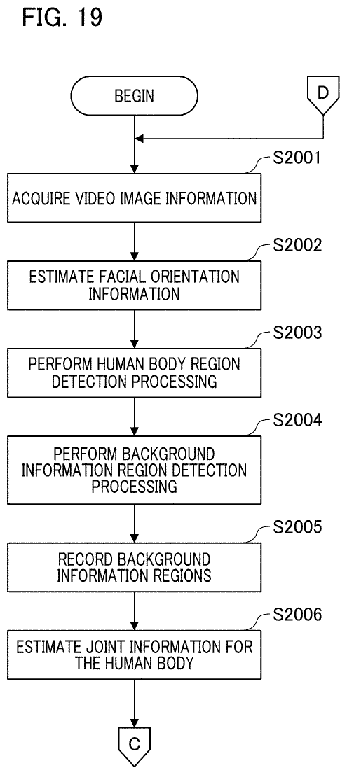

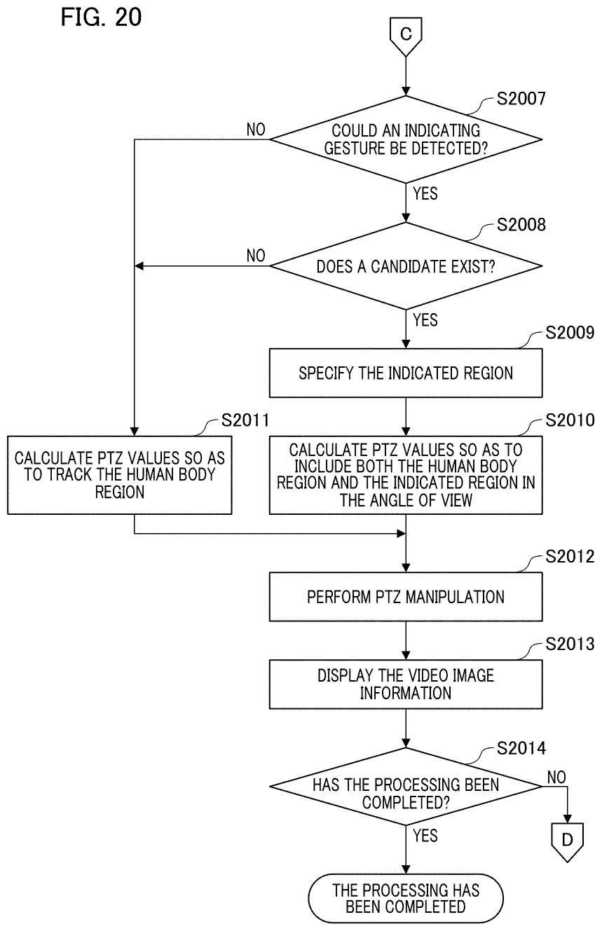

The order of the processing of the image capturing system will now be explained while referencing the flowcharts in FIGS. 19 through 21. FIGS. 19 and 20 are flowcharts showing one example of processing in an image capturing system according to the Second Embodiment. Each of the operations (steps) shown in these flowcharts can be executed by the CPU201 controlling each unit.

Automatic image capturing begins when the image capturing system B1000 is turned on by a user operation, and first, in S2001, the video image information acquisition unit B1003 acquires video image information from the video image acquisition apparatus A1001. The video image information is output to the facial orientation estimation unit B1014, the human body region detection unit A1004, the joint information estimation unit A1005, the background information region detection unit A1007, and the video image output apparatus A1013. In addition, the pan, tilt, and zoom values that have been acquired from the video image acquisition apparatus A1001 are output to the background information region recording unit A1008. Then, the processing proceeds to S2002.

In S2002, the facial orientation estimation unit B1014 performs facial orientation estimation based on the video image information that has been acquired from the video image information acquisition unit B1003, and outputs the estimation results to the specifying unit B1010. Then, the processing proceeds to S2003.

In S2003, the human body region detection unit A1004 performs human body detection processing based on the video image information that has been acquired from the video image information acquisition unit B1003, and outputs the detection results to the specifying unit B1010, and the angle of view calculation unit A1011. Then, the processing proceeds to S2004.

In S2004, the background information region detection unit A1007 performs background information region detection processing using the video image information that has been acquired from the video image information acquisition unit B1003, and outputs the detection results to the background information region recording unit A1008. Then, the processing proceeds to S2005.

In S2005, the background information region recording unit A1008 records the background information regions from the background information region detection results that have been input from the background information region detection unit A1007, and the pan, tilt, and zoom values during image capturing that have been input from the video image information acquisition unit B1003. Then the processing proceeds to S2006.

In S2006, the joint information estimation unit A1005 estimates the joint information of the human body in the video image, and outputs the estimated joint information to the gesture detection unit B1006. Then, the processing then proceeds to S2007.

In S2007, the gesture detection unit B1006 detects an indicating gesture based on the joint information. In the case in which a gesture can be detected (S2007 Yes), the direction information indicated by the gesture is calculated, the direction information is output to the candidate acquisition unit A1009, and the processing proceeds to S2008. In the case in which no gesture can be detected (S2007 No), a gesture not detected notification is output to the angle of view calculation unit A1011, and the processing proceeds to S2011.

In S2008, the candidate acquisition unit A1009 calculates the candidate regions based on the background information region information groups that have been input from the background information region recording unit A1008, and the indicated direction information that has been input from the gesture detection unit B1006. In the case in which candidate regions exist (S2008 Yes), the candidate region information is output to the specifying unit B1010, and the processing proceeds to S2009. In the case in which no candidate regions exist (S2008 No), a candidate not detected notification is output to the angle of view calculation unit A1011, and the processing proceeds to S2011.

In S2009, the specifying unit B1010 specifies the indicated region based on the human body region information that has been input from the human body region detection unit A1004 and the candidate region information that has been input from the candidate acquisition unit A1009. Then, the specifying unit B1010 outputs the specified indicated region to the angle of view calculation unit A1011, and the processing proceeds to S2010.

In S2010, the angle of view calculation unit A1011 calculates the pan, tilt, and zoom values such that both the human body region and the indicated region are included in the angle of view, from the human body region information that has been input from the human body region detection unit A1004 and the indicated region that has been input from the specifying unit B1010. The angle of view calculation unit A1011 outputs the calculated pan, tilt, and zoom values to the angle of view adjustment unit A1012, and the processing proceeds to S2012.

In S2011, when the angle of view calculation unit A1011 acquires a gesture not detected notification from the gesture detection unit B1006, or a candidate not detected notification from the candidate acquisition unit A1009, it calculates the pan, tilt, and zoom values such that the human body region is captured in the center of the angle of view. The calculated pan, tilt, and zoom values are output to the angle of view adjustment unit A1012, and the processing proceeds to S2012.

In S2012, the angle of view adjustment unit A1012 manipulates the video image acquisition apparatus A1001 based on the pan, tilt, and zoom values that have been input from the angle of view calculation unit A1011. Then, the processing proceeds to S2013.

In S2013, the video image output apparatus A1013 displays the video image information that has been input from the video image information acquisition unit B1003. Then, the processing proceeds to S2014.

In S2014, it is determined whether or not the On/Off switch of the automatic image capturing system, which is not shown, has been operated by a user operation, and an operation has been performed to stop the automatic image capturing processing. In the case that this is false (S2014 No), the processing proceeds to S1001, and in the case in which this is true (S2014 Yes), the automatic image capturing process is completed.

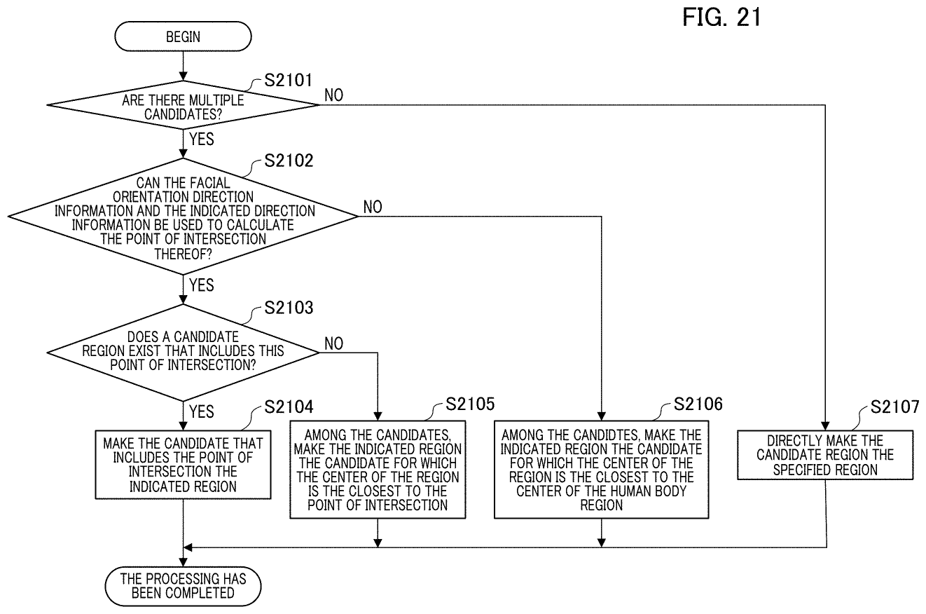

Next, a more detailed description of the order of the indicated region specification processing that is performed in S2009 will be given with reference to the flowchart in FIG. 21. FIG. 21 is a flowchart showing an example of indicated region specification processing according to the Second Embodiment. Each operation (step) that is shown in this flowchart can be executed by the CPU 201 controlling each unit.

First, in S2101, the specifying unit B1010 determines if multiple candidate regions exist based on the candidate region information that has been input from the candidate acquisition unit A1009. In the case in which multiple candidate regions exist (S2101 Yes), the processing proceeds to S2102. In the case in which there is one candidate region (S2101 No), the processing proceeds to S2107.

In S2102, the specifying unit B1010 uses the facial orientation information that has been input from the facial orientation estimation unit B1014 and the indicated direction information that has been input from the gesture detection unit B1006 to calculate the point of intersection thereof. In the case in which the point of intersection can be calculated (S2102 Yes), the processing proceeds to S2103. In the case in which the point of intersection cannot be calculated (S2102 No), the processing proceeds to S2106.

In S2103, the specifying unit B1010 determines if a candidate region that includes the point of intersection that was calculated in S2102 exists. In the case in which a candidate region that includes the point of intersection exists (S2103 Yes), the processing proceeds to S2104. In the case in which no candidate region that includes the point of intersection exists (S2103 No), the processing proceeds to S2105.

In S2104, the specifying unit B1010 specifies, from among the candidate regions, the region that includes the point of intersection calculated in S2012 as the indicated region, and outputs this to the angle of view calculation unit A1011. Then, the indicated region specification processing S2009 is completed.

In S2105, the specifying unit B1010 specifies, from among the candidate regions, the candidate region for which the center of the region is closest to the point of intersection that was calculated in S202 as the indicated region, and outputs this to the angle of view calculation unit A1011. Then, the indicated region specification processing S2009 is completed.

In S2106, the specifying unit B1010 specifies, from among the candidate regions, the candidate region for which the center of the region is the closest to the center of the human body region as the indicated region, and outputs this to the angle of view calculation unit A1011. Then, the indicated region specification processing S2009 is completed.

In S2107, the specifying unit B1010 directly specifies the one candidate region as the indicated region, and outputs this to the angle of view calculation unit A1011. Then, the indicated region specification processing S2009 is completed.

In the above described automatic image capturing system, it is possible to perform image capturing in which it is easier for the viewer to understand the circumstances in the case in which the human body that is displayed in the video image makes an indicating gesture, by performing angle of view manipulation to include not only the human body, but also the indicated region. Furthermore, by using facial orientation information, even if a plurality of background information regions exists in the indicated position and direction, it is possible to perform image capturing in which the background information region that has a high possibility of being indicated is included in the angle of view.

### Third Embodiment

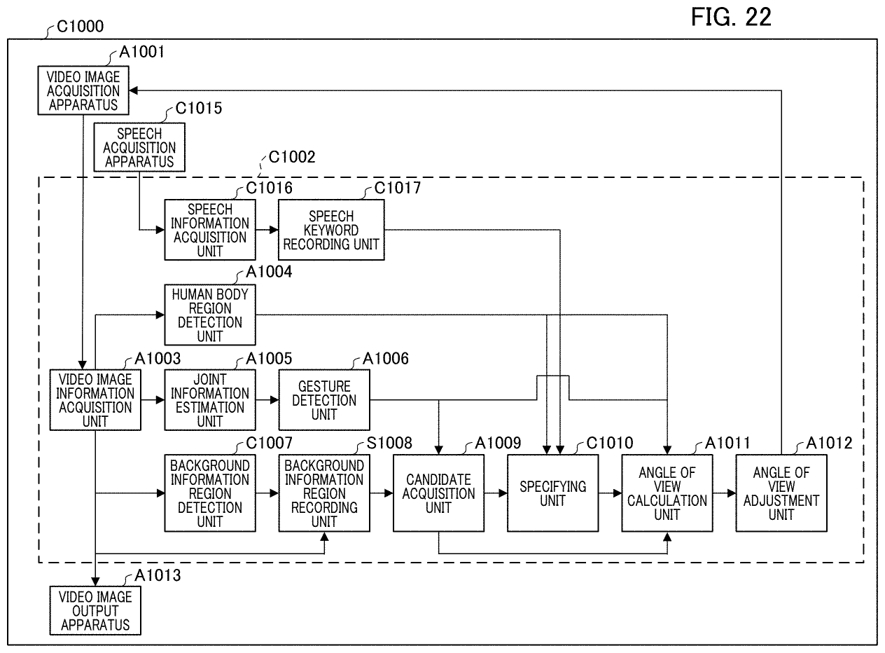

An example of a configuration of an angle of view adjustment apparatus according to the Third Embodiment of the present disclosure will be explained with reference to FIG. 22. FIG. 22 is a block diagram showing a functional configuration of an image capturing system including an angle of view adjustment apparatus according to the Third Embodiment.

An image capturing system C1000 detects a human body from the video image that has been captured by the video image acquisition apparatus A1001, and zooms in so that the entirety or the upper half of the human body is included in the angle of view and manipulates the angle of view in such a way that this is captured in the center of the angle of view via an angle of view adjustment apparatus C1002. Then, the obtained video image is output to the video image output apparatus A1013. Furthermore, during the human body tracking, in the case in which this human body performs an indicating gesture, the video image that has been obtained by manipulating the angle of view such that both the human body region and the indicated region are included in the angle of view is output to the video image output apparatus A1013. The image capturing system C1000 has a video image acquisition apparatus A1001, a speech acquisition apparatus C1015, an angle of view adjustment apparatus C1002, and a video image output apparatus A1013. The angle of view adjustment apparatus C1002 and the video image output apparatus A1013 can be connected via a video interface.

The speech acquisition apparatus C1015 is an apparatus that generates speech information by collecting sound from the surroundings at the time of image capturing using a microphone. The speech acquisition apparatus C1015 outputs the generated speech information to the angle of view adjustment apparatus C1002.

The angle of view adjustment apparatus C1002 detects a human body region, estimates the joint information for this human body, and detects background information regions based on the video image information that has been input from the video image acquisition apparatus A1001. In addition, speech recognition is performed on the speech information that has been input from the speech acquisition apparatus C1015. An indicating gesture is detected based on the estimated joint information, and an indicated region is specified based on the detected indicating gesture and the speech recognition results. In the case in which an indicated region is specified, angle of view adjustment is performed such that both of the indicated region and the human body region are included in the angle of view. The video image for which the angle of view has been adjusted is output to the video image output apparatus A1013. The angle of view adjustment apparatus C1002 has a speech information acquisition unit C1016, a speech keyword recording unit C1017, a video image information acquisition unit A1003, a human body region detection unit A1004, a joint information estimation unit A1005, and a gesture detection unit A1006. Furthermore, the angle of view adjustment apparatus C1002 also has a background information region detection unit C1007, a background information region recording unit C1008, a candidate acquisition unit A1009, a specifying unit C1010, an angle of view calculation unit A1011, and an angle of view adjustment unit A1012.

The background information region detection unit C1007 detects background information regions based on the video image information that has been input from the video image information acquisition unit A1003, along with extracting background keywords from character string information in that region. The processing for the background information region detection is the same as that of the background information region detection unit A1007, and therefore, a detailed explanation thereof will be omitted. The extraction of the character string information from inside the background information region uses, for example, OCR (Optical Character Recognition). Then, background keyword extraction from the extracted character strings is performed by using processing that performs keyword extraction such as Microsoft Azure and the like. OCR and keyword extraction are well-known technologies, and therefore detailed explanations thereof will be omitted. The detected background information regions and the extracted background keywords are output to the background information region recording unit C1008.

The background information region recording unit C1008 adds the background keywords and the pan, tilt, and zoom values during image capturing that have been input from the video image information acquisition unit A1003 to the background information region that has been input from the background information region detection unit C1007, and records them. The recorded background information region groups are output to the candidate acquisition unit A1009.

The speech information acquisition unit C1016 acquires speech information from the speech acquisition apparatus C1015, and outputs this to the speech key word recording unit C1017.

The speech keyword recording unit C1017 extracts speech keywords from the speech information that has been input from the speech information acquisition unit C1016 and records them. With respect to the speech information, for example, character string information is extracted from the speech information by using speech recognition technology such as Julius, or Microsoft Azure, and speech character string information is generated by temporarily recording this character information. Any kind of technology may be used for the speech recognition technology. Speech keywords are extracted from the speech character string information and recorded by using the previously mentioned keyword extraction technology. The speech keywords that have been recorded are output to the specifying unit C1010.

The specifying unit C1010 specifies one indicated region based on the speech keywords that have been input from the speech keyword recording unit C1017, the human body region information that has been input from the human body region detection unit A1004, and the candidate regions that have been input from the candidate acquisition unit A1009. If there is one candidate region, this region is directly made the indicated region. If multiple candidate regions exist, the degree of similarity between the background keywords from each of the candidate regions and the speech keywords that have been input from the speech keyword recording unit C1017 is calculated.

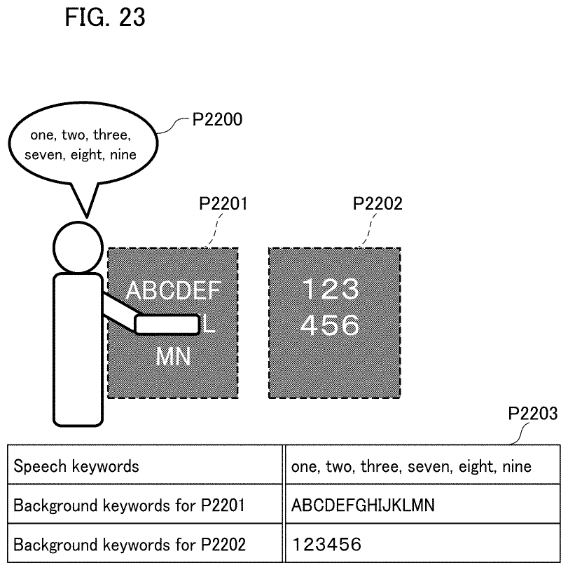

FIG. 23 is a diagram explaining indicated region specification processing according to the Third Embodiment. Chart P2203 in this drawing shows the extracted speech keywords and background keywords from the spoken contents P2200 and the regions P2201 and P2202, which are the two candidate regions. In the present example “one, two, three, seven, eight, nine” has been extracted (i.e. recognized) as the speech keywords, “ABCDEFGHIJKLMN” has been extracted as background keywords from the region P2201, and “123456” has been extracted as the background key words from the region P2202. When the degree of similarity between the speech keywords and the various background keywords is calculated, the degree of similarity for the background keywords for the region P2201 is 0.0, and the degree of similarity for the background words from the region P2202 is 0.5. Thus, the specifying unit C1010 specifies P2022, which has a higher degree of similarity, as the indicated region. Note that in the case in which there are 3 or more candidate regions, it is preferable that the candidate region with the highest degree of similarity be specified as the indicated region. In addition, specific numerical values have been shown in this context, however, the calculation for the degree of similarity does not have to be measured as between 0 to 1, and any method may be used as long as the degree of similarity for the character strings can be measured, such as, for example, the Levenshtein distance method. The specified indicated region is output to the angle of view calculation unit A1011. The other blocks are the same as those in the First Embodiment, and therefore, descriptions thereof will be omitted.

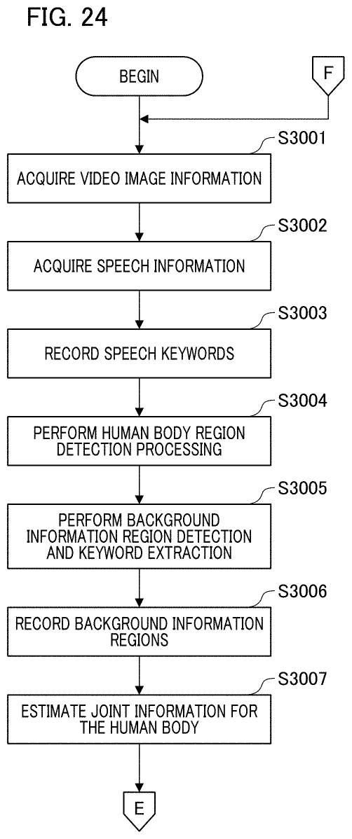

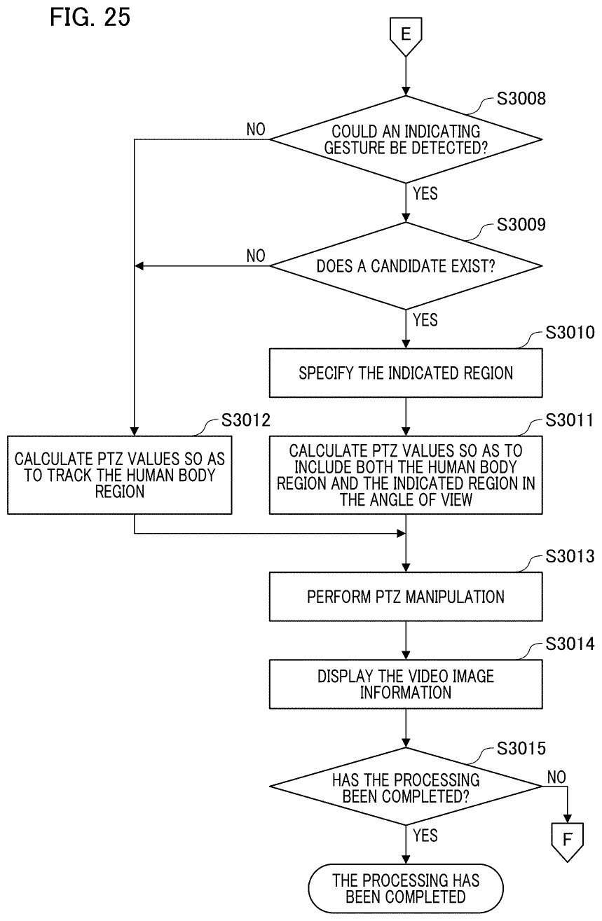

The order of processing for the automatic image capturing system will now be explained while referencing the flowcharts in FIGS. 24 and 25. FIGS. 24 and 25 are flowcharts showing examples of processing in an image capturing system according to the Third Embodiment. Each of the operations (steps) shown in these flowcharts can be executed by the CPU 201 controlling each unit.

Automatic image capturing begins when the image capturing system C1000 is turned on by a user operation, and first, in S3001, the video image information acquisition unit A1003 acquires video image information from the video image acquisition apparatus A1001. The video image information is output to the human body region detection unit A1004, the joint information estimation unit A1005, the background information region detection unit C1007, and the video image output apparatus A1013. In addition, the pan, tilt, and zoom values that were acquired from the video image acquisition apparatus A1001 are output to the background information region recording unit C1008. Then, the processing proceeds to S3002.

In S3002, the speech information acquisition unit C1016 acquires speech information from the speech acquisition apparatus C1015, and outputs this to the speech keyword recording unit C1017. Then, the processing proceeds to S3003.

In S3003, the speech keyword recording unit C1017 extracts and records speech keywords from the speech information that has been input from the speech information acquisition unit C1016. The recorded speech keywords are output to the specifying unit C1010. Then, the processing proceeds to S3004.

In S3004, the human body region detection unit A1004 performs human body detection processing based on the video image information acquired from the video image information acquisition unit A1003, and the detection results are output to the specifying unit C1010 and the angle of view calculation unit A1011. Then, the processing proceeds to S3005.

In S3005, the background information region detection unit C1007 performs background information region detection processing and background keyword extraction processing by using the video image information that has been acquired from the video image information acquisition unit A1003, and outputs the background information regions including the background keyword information to the background information region recording unit C1008. Then the processing proceeds to S3006.

In S3006, the background information region recording unit C1008 records the background information regions from the background information regions that have been input from the background information region detection unit C1007 and the pan, tilt, and zoom values during image capturing that have been input from the video image information acquisition unit A1003. Then, the processing proceeds to S3007.

In S3007, the joint information estimation unit A1005 estimates the joint information for the human body in the video image, and outputs the estimated joint information to the gesture detection unit A1006. Then the processing proceeds to S3008.

In S3008, the gesture detection unit A1006 performs indicating gesture detection based on the joint information. In the case in which a gesture can be detected (S3008 Yes), the direction information indicated by the gesture is calculated, the direction information is output to the candidate acquisition unit A1009, and the processing proceeds to S3009. In the case in which a gesture cannot be detected (S3008 No), a gesture not detected notification is output to the angle of view calculation unit A1011, and the processing proceeds to S3012.

In S3009, the candidate acquisition unit A1009 calculates the candidate regions from the background information region information groups that have been input from the background information region recording unit C1008 and the indicated direction information that has been input from the gesture detection unit A1006. In the case in which candidate regions exist (S3009 Yes), the candidate region information is output to the specifying unit C1010, and the processing proceeds to S3010. In the case in which no candidate regions exist (S3009 No), a candidate not detected notification is output to the angle of view calculation unit A1011, and the processing proceeds to S3012.

In S3010, the specifying unit C1010 specifies the indicated region based on the human body region information that has been input from the human body region detection unit A1004, the candidate region information that has been input from the candidate acquisition unit A1009, and the speech keywords that have been input from the speech keyword recording unit C1017. Then, the specifying unit C1010 outputs the specified indicated region to the angle of view calculation unit A1011, and the processing proceeds to S3011.

In S3011, the angle of view calculation unit A1011 calculates the pan, tilt, and zoom values such that both the human body region and the indicated region are included in the angle of view based on the human body region information that has been input from the human body region detection unit A1004, and the indicated region that has been input from the specifying unit C1010. The angle of view calculation unit A1011 outputs the calculated pan, tilt, and zoom values to the angle of view adjustment unit A1012, and the processing proceeds to S3013.

In S3102, when the angle of view calculation unit A1011 acquires a gesture not detected notification from the gesture detection unit A1006, or a candidate not detected notification from the candidate acquisition unit A1009, the pan, tilt, and zoom values are calculated such that the human body region is captured in the center of the angle of view. The calculated pan, tilt, and zoom values are output to the angle of view adjustment unit A1012, and the processing proceeds to S31013.

In S3013, the angle of view adjustment unit A1012 manipulates the video image acquisition apparatus A1001 based on the pan, tilt, and zoom values that have been input from the angle of view calculation unit A1011. Then, the processing then proceeds to S3014.

In S3014, the video image output apparatus A1013 displays the video image information that has been input from the video image information acquisition unit A1003. Then the processing proceeds to S3015.

In S3015, it is determined whether or not the On/Off switch of the automatic image capturing system, which is not shown, has been operated by a user operation, and an operation has been performed to stop the automatic image capturing processing. In the case in which this is false (S3015 No), the processing proceeds to S3001, and in the case in which this is true (S3015 Yes), the automatic image capturing process is completed.

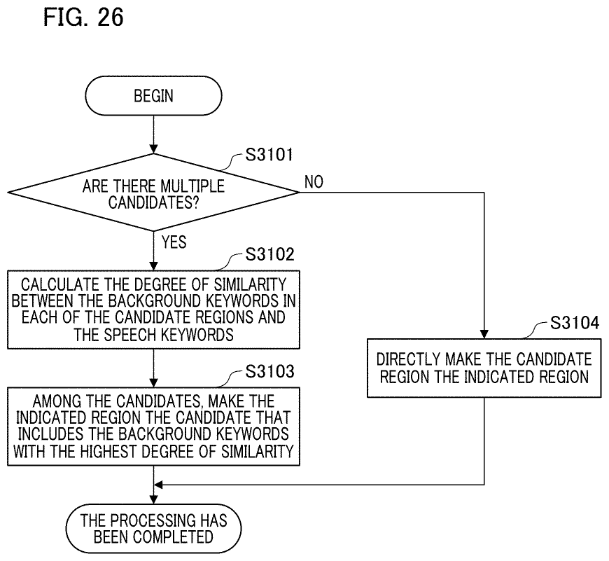

Next, a more detailed description of the order of the indicated region specification processing that is performed in S3010 will be given with reference to the flowchart in FIG. 26. FIG. 26 is a flowchart showing an example of indicated region specification processing according to the Third Embodiment. Each of the operations (steps) shown in this flowchart can be executed by the CPU 201 controlling each unit.

First, in S3101, the specifying unit C1010 determines if multiple candidate regions exist based on the candidate region information that has been input from the candidate acquisition unit A1009. In the case in which multiple candidate regions exist (S3101 Yes), the processing proceeds to S3102. In the case in which there is one candidate region (S3101 No), the processing proceeds to S3104.

In S3102, the specifying unit C1010 calculates the degree of similarity between the background keywords from the candidate region information that has been input from the candidate acquisition unit A1009, and the speech keywords that have been input from the speech keyword recording unit A1009. Then, the processing proceeds to S3013.

In S3103, the specifying unit C1010 specifies, from among the candidate regions, the region having the highest degree of similarity calculated in S3102 as the indicated region, and outputs this to the angle of view calculation unit. Then the indicated region specification processing in S3010 is completed.

In S3104, the specifying unit C1010 directly specifies the one candidate region as the indicated region, and outputs this to the angle of view calculation unit A1011. Then the indicated region specification processing S3010 is completed.

The above described automatic image capturing system is able to perform image capturing in which it is easier for the viewer to understand the conditions by manipulating the angle of view to include not just a human body but also an indicated region in the case in which the human body displayed in the video image makes a pointing gesture. Furthermore, by using speech keywords, it is possible to perform image capturing to include the background information region with the highest possibility of being the indicated region in the angle of view, even when a plurality of background information regions exists in the position and direction that have been indicated.

### Other Embodiments

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions. In addition, as a part or the whole of the control according to this embodiment, a computer program realizing the function of the embodiments described above may be supplied to the information processing apparatus through a network or various storage media. Then, a computer (or a CPU, an MPU, or the like) of the information processing apparatus may be configured to read and execute the program. In such a case, the program and the storage medium storing the program configure the present invention.

This application claims the benefit of Japanese Patent Application No. 2021-076208 filed on Apr. 28, 2021, which is hereby incorporated by reference herein in its entirety.

What is claimed is:

1. An information processing apparatus comprising at least one processor that executes the instructions and is configured to operate as:
a person detection unit configured to detect a person from an image captured by an image capturing unit;
a gesture detection unit configured to detect a first direction based on a gesture performed by the person;
a specifying unit configured to specify, as an indicated region, a background information region including background information in an image captured by the image capturing unit, in a case where the background information region and the first direction intersect; and
an angle of view adjustment unit configured to adjust an angle of view of the image capturing unit such that the person and the indicated region are included in the angle of view,
wherein in a case where a plurality of background information regions in the image and the first direction intersect, the specifying unit specifies, as the indicated region, a background information region that fulfills a predetermined condition from among the plurality of background information regions.

2. The information processing apparatus according to claim 1, wherein the at least one processor is configured to further function as:
a joint information estimation unit configured to estimate joint information for the person based on the image; and
the gesture detection unit detects the gesture performed by the person based on the joint information.

3. The information processing apparatus according to claim 1, wherein in the case where the plurality of background information regions and the first direction intersect, the specifying unit specifies the indicated region from among the plurality of background information regions, based on respective overlap amount in an image between the person and each of the plurality of background information regions.

4. The information processing apparatus according to claim 3, wherein the specifying unit specifies, as the indicated region, a background information region of which the overlap amount is below a first threshold, from among the plurality of background information regions.

5. The information processing apparatus according to claim 4, wherein in a case in where there are multiple background information regions each of which the overlap amount is below the first threshold, the specifying unit specifies the indicated region of a background information region of which a center positions the closest to the center of the person in the image.

6. The information processing apparatus according to claim 1, wherein the at least one processor is configured to further function as:
an estimation unit configured to acquire a second direction corresponding to the facial orientation of the person; and
wherein in the case where the plurality of background information regions and the first direction intersect, the specifying unit specifies the indicated region based on the point of intersection of the first direction and the second direction.

7. The information processing apparatus according to claim 6, wherein the specifying unit specifies the indicated region of a background information region including the point of intersection, or a background information region that is the closest to the point of intersection from among the plurality of background information regions.

8. The information processing apparatus according to claim 1, wherein the at least one processor is configured to further function as:
a speech recognition unit configured to recognize speech information during image capturing by the image capturing unit;
wherein in a case where the plurality of background information regions and the first direction intersect, the specifying unit specifies the indicated region from among the plurality of background information regions based on a similarity between the speech information and words recognized from each of the plurality of background information regions.

9. The information processing apparatus according to claim 1, wherein the angle of view adjustment unit extracts at least one of the human body and the indicated region, and adjusts the angle of view such that both the person and the indicated region are included in the angle of view, in a case where a distance between the center of the indicated region and the center of the human body is above a second threshold.

10. The information processing apparatus according to claim 1, wherein the background information includes character strings or figures.

11. A method of image capture processing comprising:
detecting a person from an image captured by an image capturing apparatus;
detecting a first direction based on a gesture performed by the person;
specifying, as an indicated region, a background information region including background information in an image captured by the image capturing apparatus, in a case where the background information region and the first direction intersect; and
adjusting an angle of view of the image capturing apparatus, such that the person and the indicated region are included in the angle of view,
wherein in a case where a plurality of background information regions in the image and the first direction intersect, the specifying specifies, as the indicated region, a background information region that fulfills a predetermined condition from among the plurality of background information regions.

12. A non-transitory computer-readable storage medium configured to store a program for controlling an image capturing apparatus to execute the following operations:
detecting a person from an image captured by the image capturing apparatus;
detecting a first direction based on a gesture performed by the person;
specifying, as an indicated region, a background information region including background information in an image captured by the image capturing apparatus, in a case where the background information region and the first direction intersect; and
adjusting an angle of view of the image capturing apparatus, such that the person and the indicated region are included in the angle of view,
wherein in a case where a plurality of background information regions in the image and the first direction intersect, the specifying specifies, as the indicated region, a background information region that fulfills a predetermined condition from among the plurality of background information regions.
